(19) United States
(12) Patent Application Publication
(10) Pub. No.: US 2004/0081346 A1
(43) Pub. Date: Apr. 29, 2004

(54) Non-intrusive testing system and method

(75) Inventors: Michael Louden, Mound, MN (US); Theron Weisz, Prior Lake, MN (US); Benjamin Music, Maple Grove, MN (US); Peter Lehman, Shorewood, MN (US); David Haggerty, Apple Valley, MN (US)

Correspondence Address: SCHWEGMAN, LUNDBERG, WOESSNER & KLUTH, P.A., P.O. BOX 2938, MINNEAPOLIS, MN, 55402, US

(73) Assignee: TestQuest, Inc.

(21) Appl. No.: 10/323,716

(22) Filed: Dec. 18, 2002

Related U.S. Application Data
(60) Provisional application No. 60/377,515, filed on May 1, 2002.

(51) Int. Cl. G06K 9/00

(52) U.S. Cl. 382/141; 382/181

(57) ABSTRACT

A computerized method and system for non-intrusive testing of an information processing system. This includes stimulating a system-under-test, capturing an image from the system-under-test visual output and one or more of the following: converting the captured image to a grey-scale bitmap, deriving pixel patterns from sub-portions of the captured image, normalizing the derived pixel patterns, scoring pixels in a pixel pattern according to color intensity, comparing pixel patterns with graphical object definitions, and finding and outputting matches taking into consideration tolerances for color, resolution, object spacing and overlap, and font kerning variation. The output is optionally a text string representing the recognized text within the captured image. The method and system also automatically learns new graphical object definitions when appropriately provided with graphical objects. A computer-readable media is provided that includes instructions coded thereon that when executed on a suitably programmed computer executes one or more of the above methods.

### RELATED APPLICATION

This application claims priority to U.S. Provisional Application serial No. 60/377,515 (entitled AUTOMATIC TESTING APPARATUS AND METHOD, filed May 1, 2002) which is herein incorporated by reference.

This application is related to U.S. patent application entitled METHOD AND APPARATUS FOR MAKING AND USING TEST VERBS filed on even date herewith, to U.S. patent application entitled SOFTWARE TEST AGENTS filed on even date herewith, and to U.S. patent application Ser. No. entitled METHOD AND APPARATUS FOR MAKING AND USING WIRELESS TEST VERBS filed on even date herewith, each of which are incorporated in their entirety by reference.

### FIELD OF THE INVENTION

This invention relates to the field of computerized test systems and more specifically to a method and system for font and object recognition on the user interface of a system-under-test.

### BACKGROUND OF THE INVENTION

An information-processing system is tested several times over the course of its life cycle, starting with its initial design and being repeated every time the product is modified. Typical information-processing systems include personal and laptop computers, personal data assistants (PDAs), cellular phones, medical devices, washing machines, wristwatches, pagers, and automobile information displays. Because products today commonly go through a sizable number of revisions and because testing typically becomes more sophisticated over time, this task becomes a larger and larger proposition. Additionally, the testing of such information-processing systems is becoming more complex and time consuming because an information-processing system may run on several different platforms with different configurations, and in different languages. Because of this, the testing requirements in today's information-processing system development environment continue to grow.

For some organizations, testing is conducted by a test engineer who identifies defects by manually running the product through a defined series of steps and observing the result after each step. Because the series of steps is intended to both thoroughly exercise product functions as well as re-execute scenarios that have identified problems in the past, the testing process can be rather lengthy and time-consuming. Add on the multiplicity of tests that must be executed due to system size, platform and configuration requirements, and language requirements, and one will see that testing has become a time consuming and extremely expensive process.

In today's economy, manufacturers of technology solutions are facing new competitive pressures that are forcing them to change the way they bring products to market. Being first-to-market with the latest technology is more important than ever before. But customers require that defects be uncovered and corrected before new products get to market. Additionally, there is pressure to improve profitability by cutting costs anywhere possible.

Product testing has become the focal point where these conflicting demands collide. Manual testing procedures, long viewed as the only way to uncover product defects, effectively delay delivery of new products to the market, and the expense involved puts tremendous pressure on profitability margins. Additionally, by their nature, manual testing procedures often fail to uncover all defects.

Automated testing of information-processing system products has begun replacing manual testing procedures. The benefits of test automation include reduced test personnel costs, better test coverage, and quicker time to market. However, an effective automated testing product often cannot be implemented. There are two common reasons for the failure of testing product implementation. The first is that today's products use large amounts of the resources available on a system-under-test. When the automated testing tool consumes large amounts of available resources of a system-under-test, these resources are not available to the system-under-test during testing, often causing false negatives. Because of this, development resources are then needlessly consumed attempting to correct non-existent errors. A second common reason for implementation failure is that conventional products check the results by checking result values as such values are stored in the memory of the system-under-test. While such values are supposed to correspond directly with what is displayed on a visual output device, these results do not necessarily match the values displayed on a visual output device coupled to the system-under-test. Because the tests fail to detect some errors in the visual display of data, systems are often deployed with undetected errors.

Conventional testing environments lack automated testing systems and methods that limit the use of system-under-test resources. Such environments lack the ability to check test results as displayed on a visual output device. These missing features result in wasted time and money.

What is needed is an automated testing system and method that uses few system-under-test resources and checks test results as displayed on a visual output of a system-under-test.

### SUMMARY OF THE INVENTION

The present invention provides an automated computerized method and system for non-intrusive testing of an information-processing system-under-test. The method and system perform tests on a system-under-test using very few system-under-test resources by capturing test results from a visual output port of a system-under-test.

The method includes capturing an image that represents a visual output of the system-under-test, wherein the image includes a plurality of pixels, and deriving at least a first pixel pattern representing a first sub-portion of the image. Further, the method includes comparing the first derived pixel pattern to a prespecified graphical object definition and outputting data representing results of the comparison.

Another aspect of some embodiments of the present invention provides normalizing at least some of the pixels in a derived pixel pattern.

Yet another aspect of some embodiments of the present invention provides performing text recognition on a derived pixel pattern within an extracted rectangular sub-portion of the captured image.

Another aspect of the present invention provides for the conversion of the captured image to a bitmap or a grey-scale bitmap depending on the configuration of the system performing the method or the requirements of the system-under-test.

Yet another aspect of the present invention provides for comparing of graphical object definitions of character glyphs used in written languages. The character sets include Unicode®, ASCII, and/or any other character set a system user may desire. In some embodiments, the languages include, for example, English, Hebrew, and/or Chinese. The character glyphs can be in any font that is properly configured on the both the testing system and the system-under-test. Accordingly, the output of the method in some such embodiments includes a text string corresponding to text recognized. However, the output in other such embodiments includes a set of coordinates representing a location within the captured image where the located text is found.

The present invention also provides, in some embodiments, a computer-readable media that includes instructions coded thereon that when executed on a suitably programmed computer, executes one or more of the above methods.

Yet another aspect of the present invention, provides a computerized system for testing an information-processing system-under-test, wherein the information-processing system-under-test has a visual display driver. In some embodiments, the testing system includes a memory, one or more graphical object definitions stored in the memory, an image-capture device coupled to the memory that captures an image having a plurality of pixels from a visual display driver of a system-under-test. Additionally, in these embodiments, the computerized system includes commands stored in the memory to derive at least a first pixel pattern representing at least a portion of the image from the image-capture device, a comparator coupled to the memory that generates a result based on a comparison of the first derived pixel pattern with a graphical object definition, and an output device coupled to the memory that outputs data representing a result from the comparator.

Another aspect of the present invention provides for storage of graphical object definitions. These graphical object definitions are stored in any location accessible to the test system such as a network database, network storage, local storage, and local memory.

### BRIEF DESCRIPTION OF THE DRAWINGS

FIG. 1 is a flow diagram of method 100 according to an embodiment of the invention.

FIG. 2 is a flow diagram of method 200 according to an embodiment of the invention.

FIG. 3 is a flow diagram of method 300 according to an embodiment of the invention.

FIG. 4 is a flow diagram of method 400 according to an embodiment of the invention.

FIG. 5 shows a block diagram of system 500 according to an embodiment of the invention.

FIG. 6 shows a block diagram of system 600 according to an embodiment of the invention.

FIG. 7A shows a block diagram of an output data structure 710A according to an embodiment of the invention.

FIG. 7B shows a block diagram of an output data structure 710B according to an embodiment of the invention.

FIG. 7C shows a block diagram of an output data structure 710C according to an embodiment of the invention.

FIG. 7D shows a block diagram of an output data structure 710D according to an embodiment of the invention.

FIG. 7E shows a block diagram of an output data structure 710E according to an embodiment of the invention.

FIG. 7F shows a block diagram of an output data structure 710F according to an embodiment of the invention.

FIG. 7G shows a block diagram of an output data structure 710G according to an embodiment of the invention.

FIG. 7H shows a block diagram of an output data structure 710H according to an embodiment of the invention.

FIG. 7I shows a block diagram of an output data structure 710I according to an embodiment of the invention.

FIG. 7J shows a block diagram of an output data structure 710J according to an embodiment of the invention.

FIG. 7K shows a block diagram of an output data structure 710K according to an embodiment of the invention.

FIG. 8 is a flow diagram of method 800 according to an embodiment of the invention.

FIG. 9 shows an example user interface 900 according to an embodiment of the invention.

FIG. 10 shows a block diagram of a system 1000 according to an embodiment of the invention.

FIG. 11 shows a block diagram detailing functions of portions of a system 1000 according to an embodiment of the invention.

FIG. 12 is a flow diagram of method 1200 according to an embodiment of the invention.

FIG. 13 is a schematic diagram illustrating a computer readable media and associated instruction set according to an embodiment of the invention.

FIG. 14 is an example of a captured image of a text-authoring tool used in the description of an embodiment of the invention.

FIG. 15 is a flow diagram of method 1500 according to an embodiment of the invention.

FIG. 16 shows an example user interface 1600 according to an embodiment of the invention.

### DETAILED DESCRIPTION OF THE INVENTION

In the following detailed description of the invention, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

### Non-Intrusive Testing Method

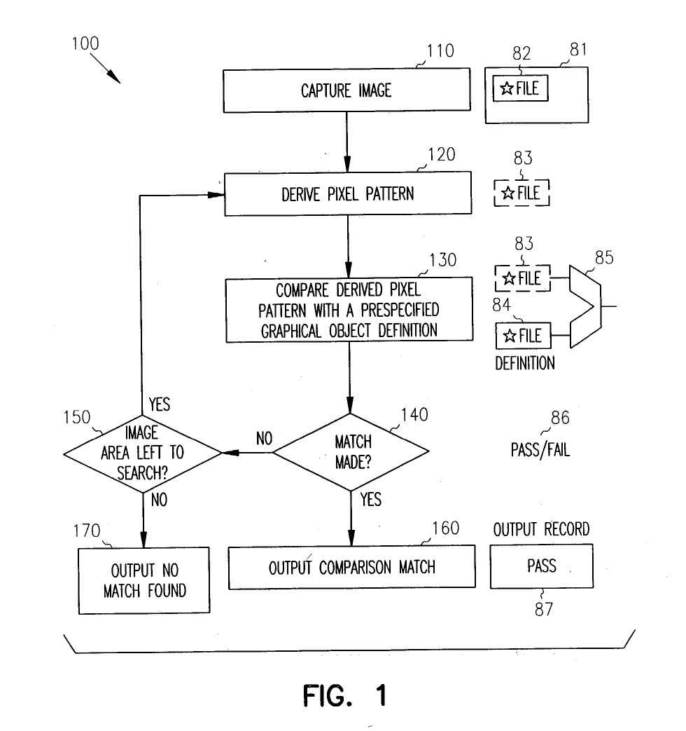

FIG. 1 shows an embodiment of method 100 for non-intrusive testing of an information-processing system-under-test. In various embodiments, the information-processing system-under-test includes a device controlled by an internal microprocessor or other digital circuit, such as a handheld computing device (e.g., a personal data assistant or “PDA”), a cellular phone, an interactive television system, a personal computer, an enterprise-class computing system such as a mainframe computer, a medical device such as a cardiac monitor, or a household appliance having a “smart” controller.

In some embodiments, method 100 includes capturing 110 an image 81 from a system-under-test visual output, deriving 120 a pixel pattern 83 from at least a sub-portion 82 of the captured image 110, and comparing 130 the derived pixel pattern 83 with a prespecified graphical object definition 84. The result of the comparison 130 is then analyzed 140 to determine if a match between the derived pixel pattern 83 and the prespecified graphical object definition 84 was made. If a comparison 130 match was made, the method outputs 160 a result 86 indicating a comparison 130 match. If a comparison 130 match was not made, the method 100 determines 150 if there is sub-portion of the captured image 110 remaining for a pixel pattern 83 to be derived 120 from. If there is not a sub-portion remaining, the method outputs 170 a result 86 indicating that a comparison 130 match was not found. Otherwise, if there is a sub-portion within the captured image 110 remaining for a pixel pattern 83 to be derived 120 from, the method 100 repeats the process of deriving 120 a pixel pattern 83 and continues repeating the portion of the method 100 after the capturing 110 of an image 81. This portion of method 100 is repeated until either an entire captured 110 image 81 has been compared 130 with a prespecified graphical object definition 84 and no comparison 130 match has been found 170 or until a comparison 130 match has been found 160.

In some embodiments of a method 100, the deriving 120 of pixel patterns includes locating and identifying pixels of a certain specified color, the pixels forming a continuous pattern within the at least a sub-portion of a captured image. In other embodiments of a method 100, all pixels, not just continuous pixels, of a certain specified color are located and identified. For example, in a captured image 110 of a word processing document displayed in a visual output of a system-under-test, assuming the background color is white and the text is black, pixel patterns are derived 120 by locating and identifying all the black pixels.

In some embodiments of method 100, the comparing 130 of a derived 120 pixel pattern 83 with a prespecified graphical object definition 84 includes comparing 130 the derived 120 pixel pattern 83 with one or more graphical object definitions 84. In one such embodiment, the comparing 130 continues until a match 160 is found. In another embodiment, the comparing 130 keeps track of a percentage of total matched pixels between the derived 120 pixel pattern 83 and a prespecified graphical object definition 84. In this embodiment, the derived 120 pixel pattern 83 is then compared 130 with another prespecified graphical object definition 84 and the percentage of matched pixels is then compared 130 with the percentage of the previous comparison 130. The greater percentage is then tracked along with the associated prespecified graphical object definition 84. This process continues until all prespecified graphical object definitions 84 have been compared 130 with the derived pixel pattern 83. The prespecified graphical object definition 84 with the largest percentage of matched pixels is then recognized as an identified graphical object and the comparison 130 for the derived pixel pattern 83 is complete.

Another embodiment of the comparison 130 also includes tracking a percentage of matched pixels. However, in this embodiment, a threshold percentage is specified for determining if a derived pixel pattern 83 has matched with a specific prespecified graphical object definition 84. For example, if the threshold percentage is set at 85 percent and 92 percent of the pixels match in a certain comparison 130, the derived 120 pixel pattern 83 is identified and the comparing 130 is complete. On the other hand, when a pixel match percentage is 79 percent and the threshold percentage is still 85 percent in such an embodiment, the comparison 130 continues.

In other comparison 130 embodiments, two threshold percentages are set for identification of a derived 120 pixel pattern 83. In one such embodiment, the first threshold percentage is a minimum pixel match threshold percentage and the second is an identified threshold percentage. The minimum percentage requires at least a minimum percentage for a derived 120 pixel pattern 83 to be considered identified once the derived 120 pixel pattern 83 has been compared 130 against all graphical object definitions 84. The maximum percentage, if met, ends the comparing and declares the derived 120 pixel pattern 83 identified. For example, the minimum percentage is set at 75 percent and the identified threshold percentage is set at 90 percent. In this example, the derived 120 pixel pattern 83 is compared 130 with a first graphical object definition 84 and 74 percent of the pixels match. This graphical object definition 84 and the matched pixel percentage are not tracked because the matched pixel percentage does not reach the minimum level. If there are no more graphical object definitions 84 to consider, the comparing 130 would end specifying that a match was not found 160. If there is a second graphical object definition 84 to compare 130 the derived 120 pixel pattern 83 against, the comparing 130 continues. If the matched pixel percentage is 75 percent, the graphical object definition 84 and match percentage is tracked. If there are no more graphical object definitions 84 to compare 130, the comparing 130 would end specifying a match was found 160. If there is a third graphical object definition 84 to compare 130 the derived 120 pixel pattern 83 against, the comparing 130 would continue. If the matched pixel percentage from the comparison 130 of the derived 120 pixel pattern 83 and the third graphical object definition 84 is greater than 75 percent but less than 90 percent, the third graphical object definition 84 and pixel match percentage will now be tracked instead of the second graphical object definition 84 and pixel match percentage. The third is now tracked because its pixel match percentage is greater than the second. If there are no further graphical object definitions 84 to compare 130, the comparing ends specifying a match was found 160 and identifying the third graphical object definition 84 as the identified graphical object. If there is a fourth graphical object definition 84 to compare 130 the derived 120 pixel pattern 83 against, the comparing 130 continues. If the pixel match percentage between the derived 120 pixel pattern 83 and the fourth graphical object definition 84 is 90 percent or greater, a match has been found and no further comparing 130 occurs. Because the fourth graphical object definition 84 met the identified threshold percentage, the derived 120 pixel pattern 83 is considered identified. The comparing ends specifying a match was found 160 and identifying the fourth graphical object definition as the identified graphical object.

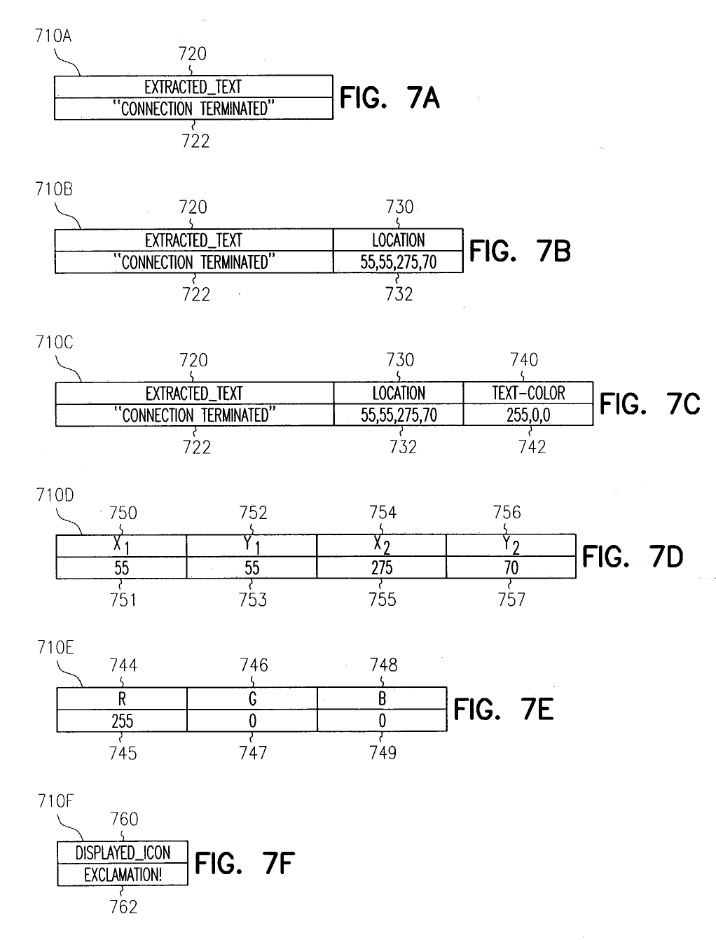

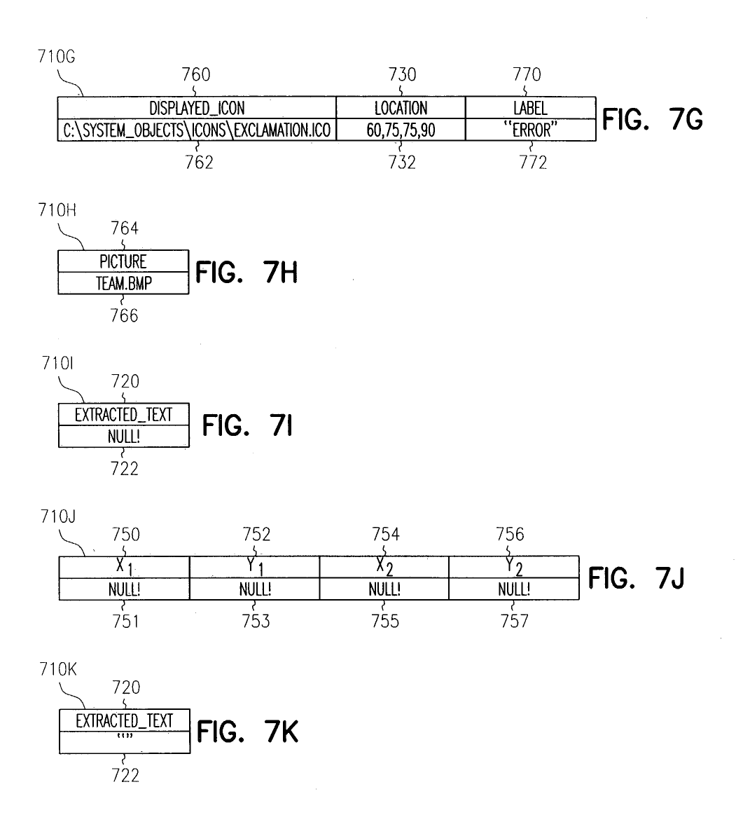

In some embodiments of the method 100 for non-intrusive testing of an information-processing system-under-test, the output 160 of the method 100 includes a text string corresponding to text represented on a visual output device of the system-under-test. In other embodiments, the output 160 is data representing a location or region within a visual output of a system-under-test. In some other embodiments, the output 160 is data representing the display color of an identified graphical object. Examples of various embodiments of the output of the method are shown in FIGS. 7A through 7K.

FIG. 7A shows a data structure 710A that is used in some embodiments of the method 100. The output data 722 represents text extracted from a visual output device of a system-under-test. The text string 722, “Connection terminated.” Was identified and output 160 by the method 100. Another embodiment of this data structure is shown in FIG. 71. However, in the FIG. 71 embodiment, the output 160 data 722 is a null value 722. The output 170 of a null return value 722, in various embodiments, includes indicating that a prespecified graphical object was not located and indicating that a located graphical object was not identified. FIG. 7K shows yet another embodiment of this data structure. However, in FIG. 7K, the output 170 data 722 is an empty string 722. In various embodiments, the use of an empty string output 170 value includes indicating that a graphical object was located but not identified.

FIG. 7B shows a data structure 710B used in another embodiment of an output of 160 the method 100. The data structure 710B presents the extracted text 722 and the coordinates 732 where the extracted text 722 was located by the method 100 within a visual output of a system-under-test.

FIG. 7C shows yet another embodiment of a data structure 710C output 160 from the method 100. This embodiment also includes the color 742 of the text 722 extracted from a visual output of the system-under-test.

FIG. 7D is an embodiment of an output 160 from the method 100. This embodiment shows a data structure 710D that conveys a location or region within a visual output of a system-under-test.

FIG. 7E shows another embodiment of an output 160 data structure 710E from the method 100. This output 160 data structure 710E provides a Red 744, Green 746, Blue 748 color code with the individual color codes (e.g., 745, 747, 749) separated. Such an output 160 embodiment is used in various method embodiments when the required output 160 of the method 100 embodiment is the color of an identified graphical object.

FIG. 7F is one more embodiment of an output 160 data structure 710F. This output 160 data structure 710F conveys the name 762 of an identified icon 760 displayed in a visual output of a system-under-test.

FIG. 7G is another embodiment of an output 160 data structure 710G that conveys data corresponding to an identified icon 762 displayed in a visual output of a system-under-test. However, this embodiment provides more information. The data conveyed in one such embodiment includes path and file name 762 data representing the identified icon 762, which computer-readable media the identified icon 762 is stored in, and where within the computer-readable media the identified icon 762 can be found. Further, this embodiment conveys the location and/or region 732 within a visual output of a system-under-test where the identified icon 762 is located and the text label 772 associated with the identified icon 762.

FIG. 7H is an embodiment of an output 160 data structure 710H that conveys data representing an identified picture 766. Such an embodiment conveys the name 766 of the identified picture file.

FIG. 7J is another embodiment of an output 160 data structure 710J. This output 160 data structure 710J is used to convey a location or region within a visual output of a system-under-test. The location or region conveyed by the data structure 710J is used for a variety of reasons in different embodiments of the method 100. These reasons include conveying a specific location where an identified graphical object is located within a visual output of a system-under-test, conveying a region that an identified graphical object occupies within a visual output of a system-under-test, and conveying a region extracted from a visual output of a system-under-test.

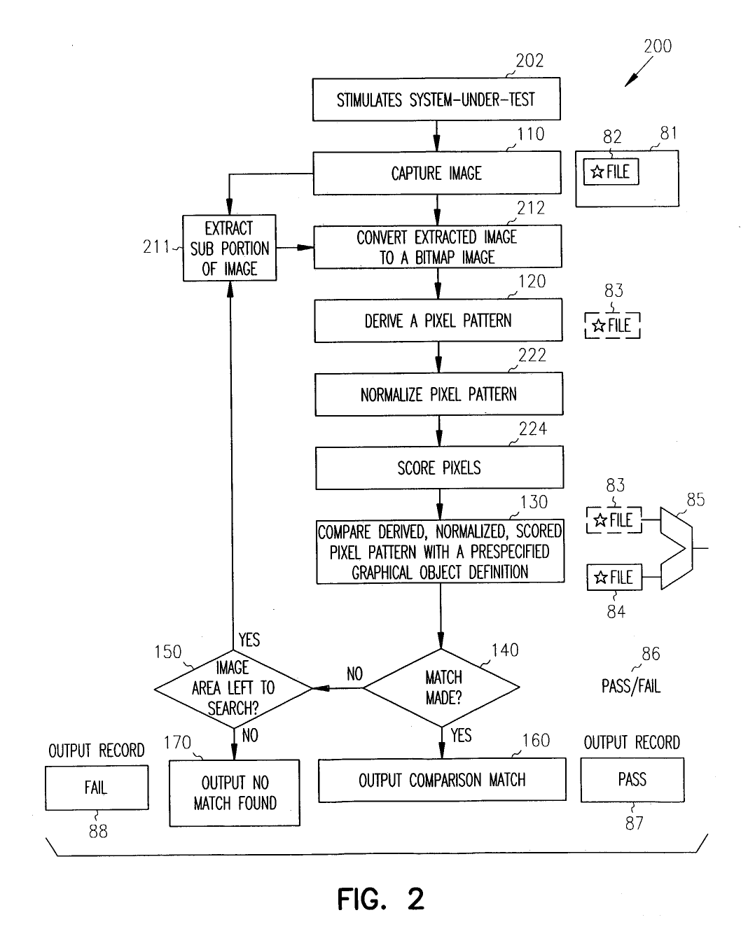

Another embodiment of the method is shown in FIG. 2. The method 200 includes stimulating 202 a system-under-test, capturing 110 an image 81 from a visual output device of a system-under-test, and extracting 211 a sub-portion 82 of the image 81. In this embodiment the method 200 continues by converting 212 the extracted 211 image sub-portion 83 to a bitmap image, deriving 120 a pixel pattern 83 from the extracted 211 image sub-portion 82, normalizing 222 the pixel pattern 83, scoring 224 the pixels within the pixel pattern 83 and comparing 130 the derived 120, normalized 222, and scored 224 pixel pattern 83 with a prespecified graphical object definition 84. This method 200 embodiment next determines 140 if a comparison 130 match was made between the pixel pattern 83 and the prespecified graphical object definition 84. If it is determined 140 that a comparison 130 match was made, the method 200 outputs 160 a result 87 indicating a comparison 130 match. If it is determined 140 that a comparison 130 match was not made, the method 200 determines 150 if there is a sub-portion 82 within the captured image 81 remaining to be extracted 211 for a pixel pattern 83 to be derived 120 from. If not, the method 200 outputs 170 a result 88 indicating that a comparison 130 match was not found. Otherwise, if there is a sub-portion 82 within the captured 110 image 81 remaining to be extracted 211 for a pixel pattern 83 to be derived 120 from, the method 200 repeats the process of extracting 211 an image sub-region 82 and continues repeating the portion of method 200 after the capturing 110 of an image 81. This portion of method 200 repeats until either the entire captured 110 image 81 has been compared 130 with a prespecified graphical object definition 84 and no comparison 130 match has been found 170 or until a comparison 130 match has been found 160.

In some embodiments, stimulating 202 a system-under-test includes simulating actions on a system-under-test. In various embodiments, these simulation actions include, but are not limited to, one or more of the following: mouse clicks, keyboard strokes, turning the system-under-test power on and off, handwriting strokes on a handwriting recognition sensor, touches on a touch screen, infrared signals, radio signals and signal strength, serial communication, universal serial bus (USB) communication, heart beats, and incoming and outgoing phone calls.

In some embodiments, capturing 110 an image 81 from a video-output device of a system-under-test includes capturing 110 analog video data output from an output device of a system-under-test and storing the data in a memory or other computer-readable media coupled to a testing system implementing the method 200. Other embodiments include capturing 110 digital video-output data. In various embodiments, the video-output data is intended for display on devices including a VGA monitor, an LCD monitor, and a television. The video data is transmitted by a system-under-test video-output device in a carrier wave in various embodiments through connections including, but not limited to, one or more of the following: S-Video cable, serial communication cable, USB cable, parallel cable, infrared light beam, coaxial cable, category 5e telecommunications cable, and Institute of Electrical and Electronics Engineers (IEEE) standard 1394 FireWire®.

In some embodiments, extracting 211 a sub-portion 82 of a captured 110 image 81 includes selecting a prespecified area of a captured 110 image 82 and storing a copy of the prespecified area in a memory or other computer-readable media coupled to a testing system implementing the method 200. In some other embodiments, extracting 211 a sub-portion 82 of a captured 110 image 81 includes selecting an area of a specific size and storing a copy of the prespecified area in a memory or other computer-readable media coupled to a testing system implementing the method 200. If an embodiment of method 200 includes iterative processing of a captured 110 image 81, the embodiments of extracting 211 a sub-portion 82 of a captured 110 image 81 are repeated as required by the embodiment of the method 200.

In some embodiments, converting 212 the extracted 211 image 81 sub-portion 82 to a bitmap includes storing the extracted 211 image 81 sub-portion as a bitmap file type. In various embodiments, the bitmap file is stored in a memory coupled to a testing system implementing the method 200. In some other embodiments, the bitmap file is stored in a computer-readable media coupled to a testing system implementing the method 200.

In some embodiments, normalizing 222 a bitmap image includes converting the bitmap image to a prespecified number of colors. In one such embodiment, converting the bitmap image to a smaller prespecified number of colors than the bitmap image was originally converted to reduces noise associated with the image 81 capture 110. Noise reduction is necessary in some embodiments of the method 200 when a system-under-test video-output device outputs an analog signal that is digitized when an image 81 is captured 110. Analog signals often include interference that causes signal noise. Often the signal noise appears in the captured 110 image 81 as color-distortion in one or more pixels of a capture 110 image 81. An example of an embodiment using normalization 222 to reduce signal noise includes a bitmap image converted from a 256-color bitmap image to a sixteen-color bitmap image. In this embodiment, pixels of colors not included in the sixteen colors used in a sixteen-color bitmap image are converted to the color closest to the 16 available colors. This color conversion eliminates pixels that are of stray colors caused by noise. Also in this normalization 222 embodiment, the normalization 222 removes colors used in the visual output for reasons such as font smoothing.

In some embodiments, scoring 224 pixels includes scoring 224 each pixel in at least a sub-portion 82 of a captured 110 image 81. In one such embodiment, the scoring 224 includes scoring 224 each pixel in at least a sub-portion 82 of the captured image 81 with a number from zero to nine, in correlation to a pixel's color intensity.

In some embodiments of a method 200, deriving 120 a pixel pattern 83 from a processed captured 110 image 81 includes using pixel-scoring 224 results. In one such embodiment, pixel patterns 83 are identified by locating continuous areas of high pixel scores. For example, if a scored 224 captured 110 image 81 contains a continuous area of high pixel scores, the area encompassed by the high pixel scores is considered a pixel pattern 83 for comparison 130 later in the method 200. In some embodiments for identifying text represented in a visual output of a system-under-test, the method 200 looks to the pixels with the lowest color intensity score 224 and the pixels with the highest color intensity score 224. In these embodiments, it is initially assumed that the highest scores are the character glyphs in one or more fonts representing text and the lowest scores are the background. However, in some embodiments, the method 200 provides for identifying text represented by the lowest pixel scores and scores between the highest and lowest.

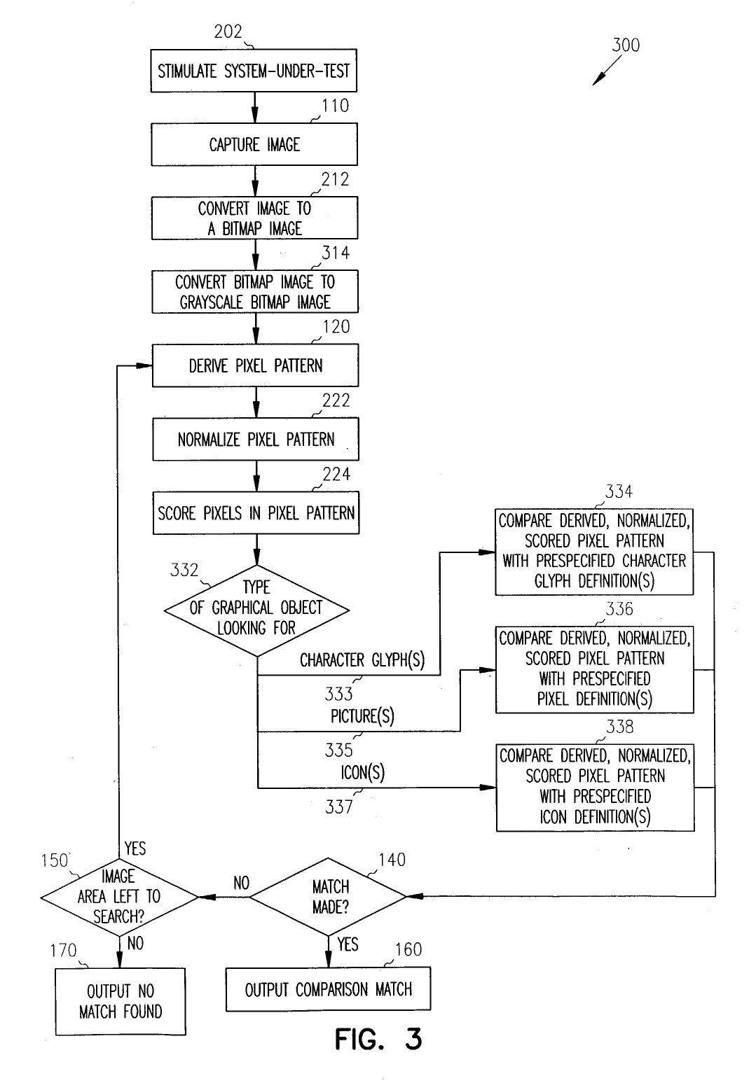

Another embodiment of the method 200 for non-intrusive testing of an information-processing system-under-test is shown in FIG. 3. The method 300 is very similar to the method 200 shown in FIG. 2. For the sake of clarity, as well as the sake of brevity, only the differences between the method 200 and the method 300 will be described. The method 300 includes converting 212 a captured 110 image 81 to a bitmap image and further converting 314 the bitmap image to a grey-scale bitmap image. In contrast, the method 200 only converts 212 a captured 110 image 81 to a bitmap image. The method 300 includes converting 314 a bitmap image to a grey-scale bitmap image for purposes of captured 110 image 81 noise reduction.

Further, method 300 includes determining 332 what type of graphical object definition 84 is being sought and performing a comparison process specifically for that type of graphical object definition (e.g., 334, 336, 338). In one such embodiment, specific comparison processes exist for character glyphs 334, pictures 335, and icons 336. In this embodiment, as shown in FIG. 3, the method 300 determines 332 what type of graphical object is being sought and the specific comparison process for the type of graphical object is then used.

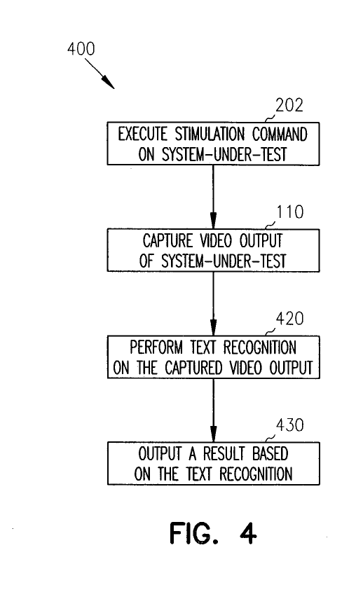

FIG. 4 shows an embodiment of a method 400 for non-intrusive testing of an information-processing system-under-test. This embodiment is tailored for instances when the testing only requires text recognition 420 to be performed on a captured 110 image 81 representing the video-output of a system-under-test. The method, as shown in the FIG. 4 embodiment, shows the executing 202 of a stimulation command to the system-under-test, but it is to be understood that a stimulation command 202 does not need to be issued to the system-under-test in order to perform the method 400.

FIG. 12 is another embodiment of the method 1200 for non-intrusive testing of an information-processing system-under-test. The method 1200 is very similar to the method 300 shown in FIG. 3. For the sake of clarity, as well as the sake of brevity, only the differences between the method 300 and the method 1200 will be described. The method 1200 includes optional pre-processing 1270. The optional pre-processing 1270 is shown occurring prior to the scoring 224 of pixels in a derived 120 pixel pattern 83. It should be noted that the method 1200 is only one embodiment of the invention. It should be noted that optional pre-processing 1270 occurring elsewhere in the method 1200 is contemplated as various embodiments of the invention.

The optional preprocessing 1270 in this embodiment includes three processes. The first optional pre-processing 1270 process is specifying 1272 pixels within at least a portion 83 of a captured 110 image 81 to ignore during the pixel pattern comparison 130. Second, handling 1274 font kerning by specifying pixel pattern pixels or regions that are shared between character glyphs in a particular font and either ignoring those pixels or regions or simultaneously identifying two or more kerned character glyphs occurring sequentially in a pixel pattern 83. Third, handling 1276 variable character spacing and overlapping by specifying pixels or regions of one or more character glyphs to ignore and/or specifying a character spacing tolerance range.

It should be noted that the order of the optional pre-processing 1270 processes described above is for illustrative purposes only. It is contemplated that these processes occurring in alternate orders is contemplated as various embodiments of the invention. In further embodiments, the optional pre-processing 1270 includes other processes. In various embodiments, these other processes include extracting 211 a sub-portion 82 of a captured 110 image 81, converting 212 a captured image 81 to a bitmap image, converting 314 an extracted 211 image to a grey-scale bitmap image, normalizing 222 a pixel pattern 83, scoring 224 pixels in a pixel pattern 83 according to a pixel's color intensity, and performing 420 text recognition on the captured 110 image 81. In these various embodiments, the order in which these process occur varies with the specific testing requirements for the method 1200 embodiment.

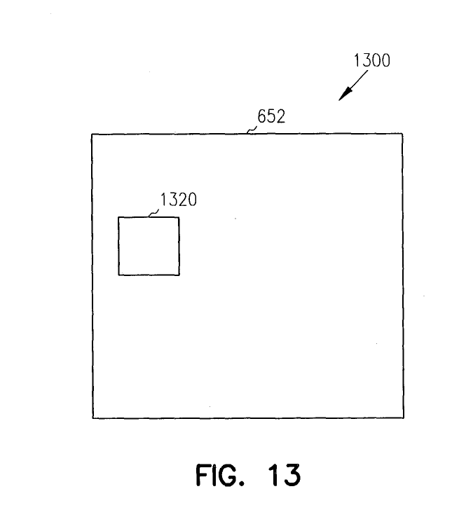

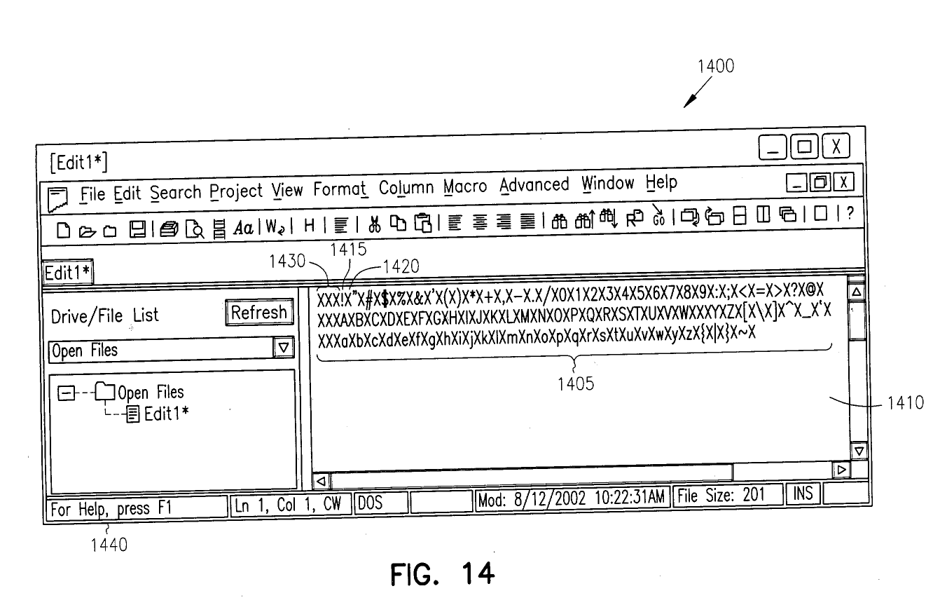

FIG. 13 is a schematic drawing of a computer-readable media 652 and an associated instruction set 1320 according to an embodiment of the invention. The computer-readable media 652 can be any number of computer-readable media including a floppy drive, a hard disk drive, a network interface, an interface to the internet, or the like. The computer-readable media can also be a hard-wired link for a network or be an infrared or radio frequency carrier. The instruction set 1320 can be any set of instructions that are executable by an information handling system associated with the automated computerized method discussed. For example, the instruction set can include the method 100, 200, 300, 400, and 1200 discussed with respect to FIGS. 1, 2, 3, 4, and 12. Other instruction sets can also be placed on the computer-readable medium 1320.

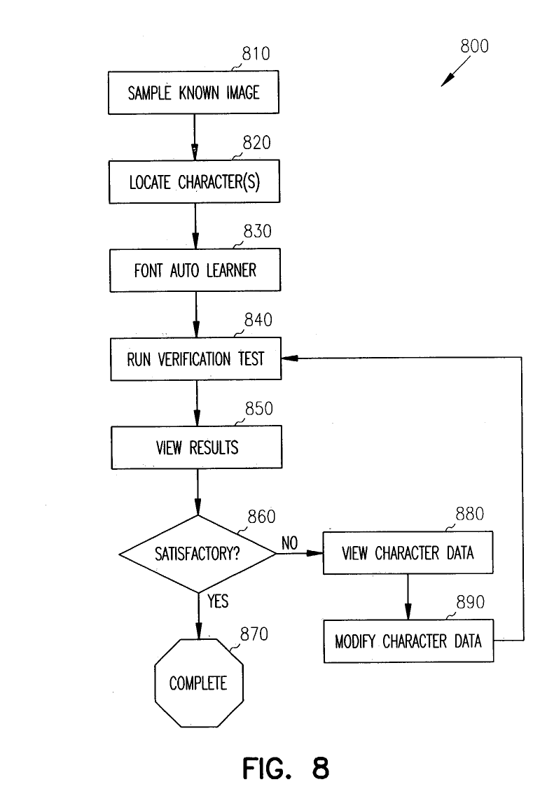

Some embodiments of a method for non-intrusive testing of a system-under-test also include a method for automated learning of character glyph definitions. An embodiment of a method 800 for automated learning of character glyph definitions is shown in the FIG. 8 flow diagram. This embodiment includes sampling 810 a known image containing characters in a sequence corresponding to a character code sequence, locating 820 one or more characters in the sampled image and specifying the an identified character's character code, executing 830 a Font Learning Wizard, running 840 verification tests, viewing 850 results, and determining 860 if the results are satisfactory. If the results are determined 860 to be unsatisfactory, the method 800 continues by viewing 880 the character data, modifying 890 the character data, and re-running the verification tests 840. Once the verification test 840 results are determined 860 satisfactory, the method 800 is complete.

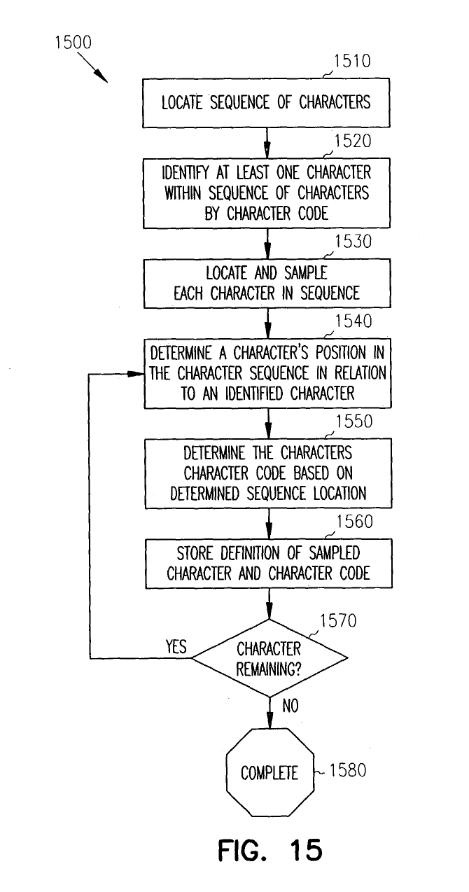

An embodiment of the Font Learning Wizard mentioned above is shown in FIG. 15. In some embodiments, the Font Learning Wizard operates by locating 1510 a sequence of characters in a certain font, identifying 1520 at least one character within the sequence of characters with a character code, locating and sampling 1530 a graphical definition of each character in the character sequence, determining 1540 a character's position in the character sequence in relation to the identified character(s), and determining 1550 the character's character code based on the character's character sequence location, and storing 1560 a definition of the sampled character. This Font Learning Wizard embodiment next determines 1570 if there are any characters remaining in the character sequence to be identified. If there are characters remaining, the method 1500 repeats the portion of the method after the locating and sampling 1530 of graphical definitions of each character. If it is determined 1570 that there are not any characters remaining to be identified, the Font Learning Wizard is complete 1580.

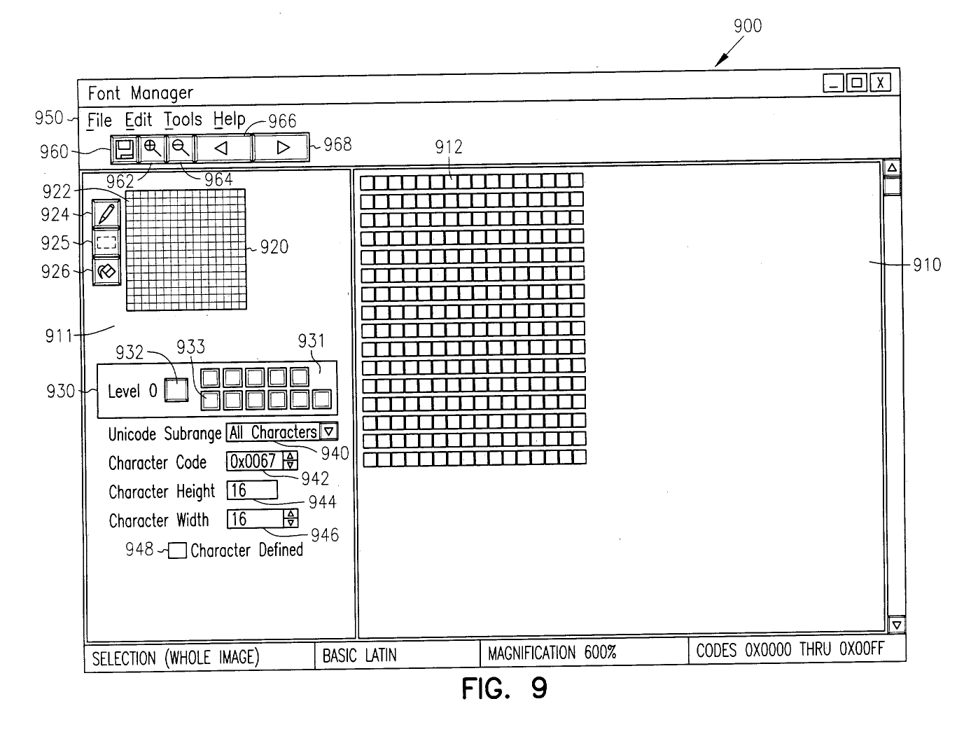

Returning to FIG. 8, the viewing 850 of results, viewing 880 of character data, and modifying 890 of character data within method 800 is performed using a portion of a system implementing the method for non-intrusive testing of an information-processing system-under-test. In some embodiments, the portion of the system includes a user interface 900 as shown in FIG. 9. In one such embodiment, the area 910 of the user interface 900 includes characters defined for a font. Each defined character is displayed in a box 912. When a character box 912 is selected, the character definition data is displayed in area 911 of the user interface 900. This area 911 displays the pixels of the selected character, the associated character code 942, the character height 944, and the character width 946. The displayed pixels of a selected character are editable using the editing tools (e.g., pixel edit 924, select area 925, and fill area 926). When editing a character pixel 922 or an area of character pixels 922, a color 933 is selected for the editing tool (e.g., pixel edit 924 and fill area 926) of choice. Within the available colors is a color 931 for specifying one or more pixels to ignore during pixel pattern comparing. Additionally, the user interface 900 provides navigation tools to navigate defined character sets in different fonts (e.g., 966 and 968), the ability to zoom the pixel editing view 920 in 962 and out 964, and the ability to save 960 changes.

### Non-Intrusive Testing System

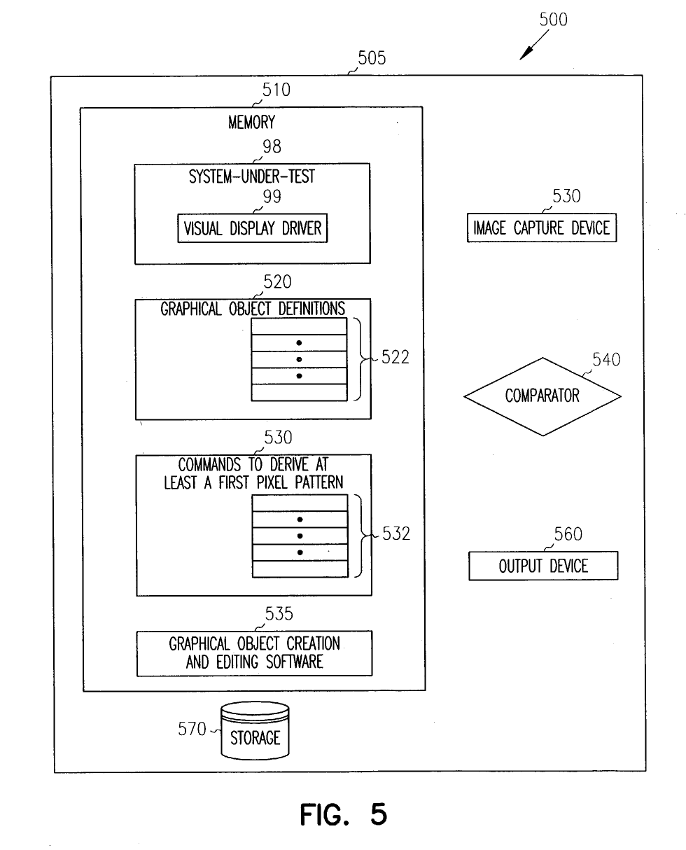

FIG. 5 shows a block diagram of a system 500 for non-intrusive testing of an information-processing system-under-test 98 according to an embodiment of the invention. In this embodiment, the system 500 includes an information-processing system 505 containing a memory 510, an image capture device 530, a comparator 540, an output device 560, and a storage 570. In various embodiments, the memory 510 holds a system-under-test 98 having a visual display driver 99, graphical object definitions 522, commands 530 to derive at least a first pixel pattern, and software 535 for defining and editing graphical object definitions.

In some embodiments, the output device 560 of a testing system 505 includes, but is not limited to, a print driver, a visual display driver, a sound card, and a data output device that provides processed data and/or results to another computer system or a software program executing on the testing system 505.

In various embodiments, the graphical object definitions 522 includes definitions of character glyphs, icons, and pictures. In one such embodiment, the graphical object definitions 522 include only character glyph definitions corresponding to characters in one or more fonts used in one or more written languages. These languages include, but are not limited to, English, Hebrew, and Chinese.

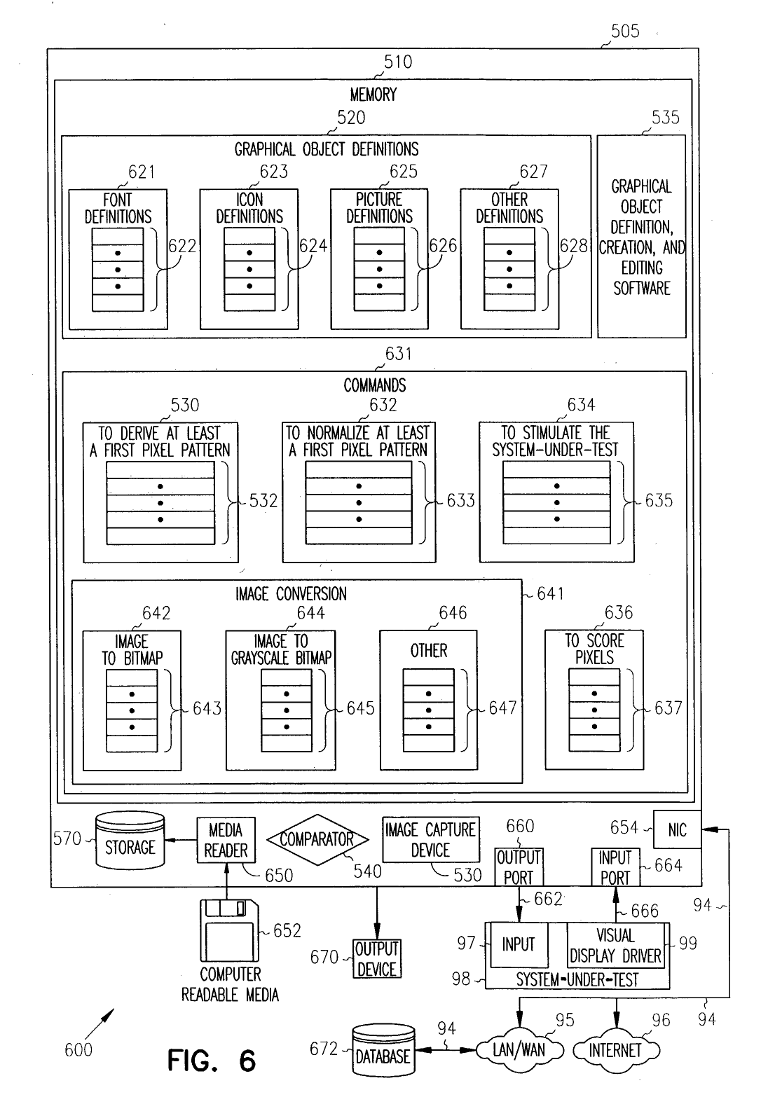

FIG. 6 is a block diagram of a system 600 according to an embodiment of the invention. In this embodiment, system 600 includes an information-processing system 505, a memory 510, a storage 570, a comparator 540, a media reader 650, a computer readable media 652, an image capture device 530, an output port 660, an input port 664, a network interface card 654, and an output device 670. In some embodiments, system 600 is coupled to a system-under-test 98 by connecting output port 660 to a system-under-test 98 input port 97 with connector 662 and connecting a system-under-test 98 visual display driver 99 output to input port 664 with connector 666.

In some other embodiments, a system 600 also includes a connection 94 between the network interface card 654 and a local area network (LAN) 95 and/or wide area network (WAN) 95, a database 972, and/or the Internet 96.

In various embodiments, the output device 670 includes, but is not limited to, a television, a CRT or LCD monitor, a printer, a wave table sound card and speakers, and a LCD display.

In some embodiments, the computer readable media 652 includes a floppy disk, a compact disc, a hard drive, a memory, and a carrier signal.

In some embodiments, the memory 510 of a system 600 embodiment contains graphical object definitions 520, commands 631 for performing specific tasks, and software 535 for defining and editing graphical object definitions. In one such embodiment, the graphical object definitions 520 include font definitions 622, icon definitions 624, picture definitions 626, and other graphical object definitions 628. In another such embodiment, the commands 631 for performing specific tasks include commands 532 to derive at least a first pixel pattern from a captured image, commands 633 to normalize at least a first pixel pattern from a captured image, stimulation commands 635 for stimulating a system-under-test 98, commands 637 for scoring pixels in a derived pixel pattern, and image conversion commands 641. In various embodiments, the image conversion commands 641 include commands 643 for converting a captured image to a bitmap, commands 645 for converting a captured image to a grey-scale bitmap, and other 647 conversion commands.

In various embodiments, the software 535 for defining and editing graphical object definitions includes an automated graphical object learning procedure. In one such embodiment, the automated graphical object learning procedure automates the defining of character glyphs of a font used in a written language. In one such embodiment, this procedure is named “Font Learning Wizard.” In this embodiment, the Font Learning Wizard allows a testing system to automatically learn a sequence of characters from a bitmap capture on the system-under-test. The Font Learning Wizard provides systematic, on-screen instructions for learning a font.

One embodiment of a Font Learning Wizard operates as described in this paragraph. It should be noted that differing embodiments of a Font Learning Wizard are contemplated as part of the invention. First, the Font Learning Wizard instructs the testing system user to create a delimited sequence of characters 1405 on the system-under-test using any text-authoring tool 1440 in the desired font as shown in FIG. 14. The delimiter 1420 as shown in FIG. 14 is “X.” Every line of characters begins with three “X” characters 1430 (e.g., “XXX”). The sequence of characters 1405 in FIG. 14 is intentional. The sequence 1405 relates to the Unicode® Standard 3.0 sequence of Basic Latin characters. Next, the Font Leaning Wizard instructs the testing system user to capture an image of the delimited sequence of characters and paste the captured image into the Font Learning Wizard. The testing system user then selects the delimiter character 1420 in the pasted image and identifies the foreground and background colors (as shown in FIG. 14, the foreground color is black and background white). Additionally, a color variance tolerance is set if desired. Next, the testing system user identifies the first character in a specific line of characters to be identified and matches the character glyph with its appropriate character code. For example, assuming the system 600 is learning a font according to the Unicode® Basic Latin character set, the character code for the first character, “!” 1415, in the first line oftext in the captured image 1400 is set to “0021.” The testing system user then issues a command to the Font Learning Wizard to learn the characters. The Font Learning Wizard then learns all characters in the first line of text and stores the character definitions. The testing system user is then given the option of inspecting, and if necessary correcting, the learned character definitions. This process is repeated for each line of text in the captured image.

In some embodiments, when a testing system user inspects and edits a character definition, the user interface 900 shown in FIG. 9 is used. The area 910 of the user interface 900 includes the characters defined for a font. Each defined character is displayed in a box 912. When a character box 912 is selected, the character definition data is displayed in area 911 of the user interface 900. This area 911 displays the pixels 922 of the selected character, the associated character code 942, the character height 944, and the character width 946. The displayed pixels 922 of a selected character are editable using the editing tools (e.g., pixel edit 924, select area 925, and fill area 926). When editing a character pixel 922 or an area of character pixels 922, a color 933 is selected for the editing tool (e.g., pixel edit 924 and fill area 926) of choice. Within the available colors is a color 931 for specifying one or more pixels 922 to ignore during pixel pattern comparing. Additionally, the user interface 900 provides navigation tools to navigate defined character sets in different fonts (e.g., 966 and 968), the ability to zoom the pixel editing view 920 in 962 and out 964, and the ability to save 960 changes.

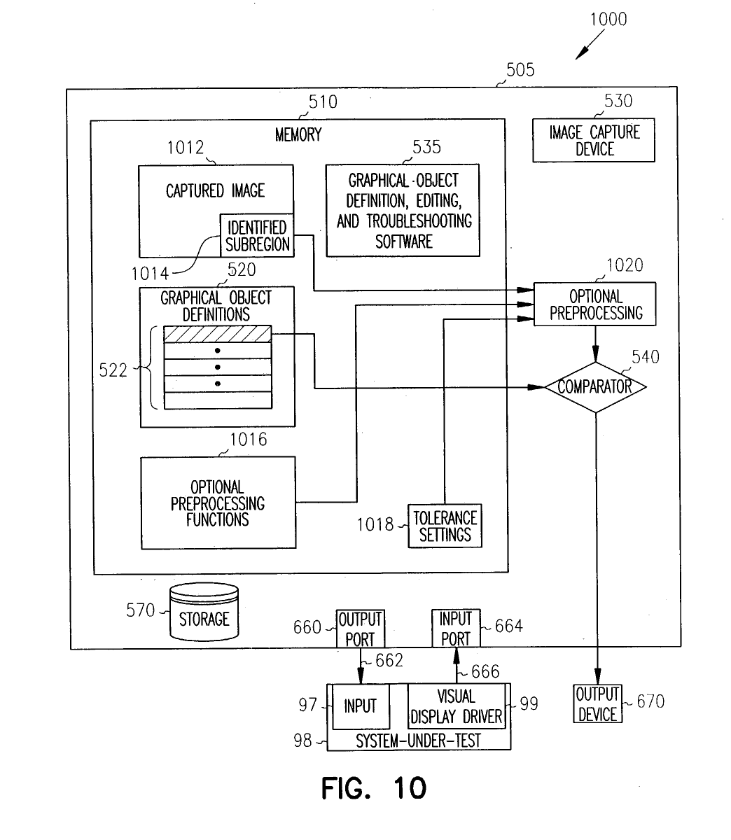

FIG. 10 shows another embodiment of a system 1000 for non-intrusive testing of an information-processing system-under-test. This system 1000 embodiment includes a testing system 505 containing a memory 510. The memory 510 holds a captured image 1012 from a system-under-test 98 visual display driver 99, a copy of an identified subregion 1014, graphical object definitions 520, optional pre-processing functions 1016, tolerance settings 1018, and graphical object defining, editing, and troubleshooting software 535. The testing system 505 in this embodiment also contains an image capture device 530, optional preprocessing 1020, a comparator 540, a storage 570, an output port 660, and an input port 664. Additionally, in some embodiments, an output device 670 is coupled to the testing system 505. This system 1000 embodiment is very similar to the embodiments shown if FIGS. 5 and 6. For the clarity, and the sake of brevity, only the additional features of the system 1000 embodiment will be described in detail.

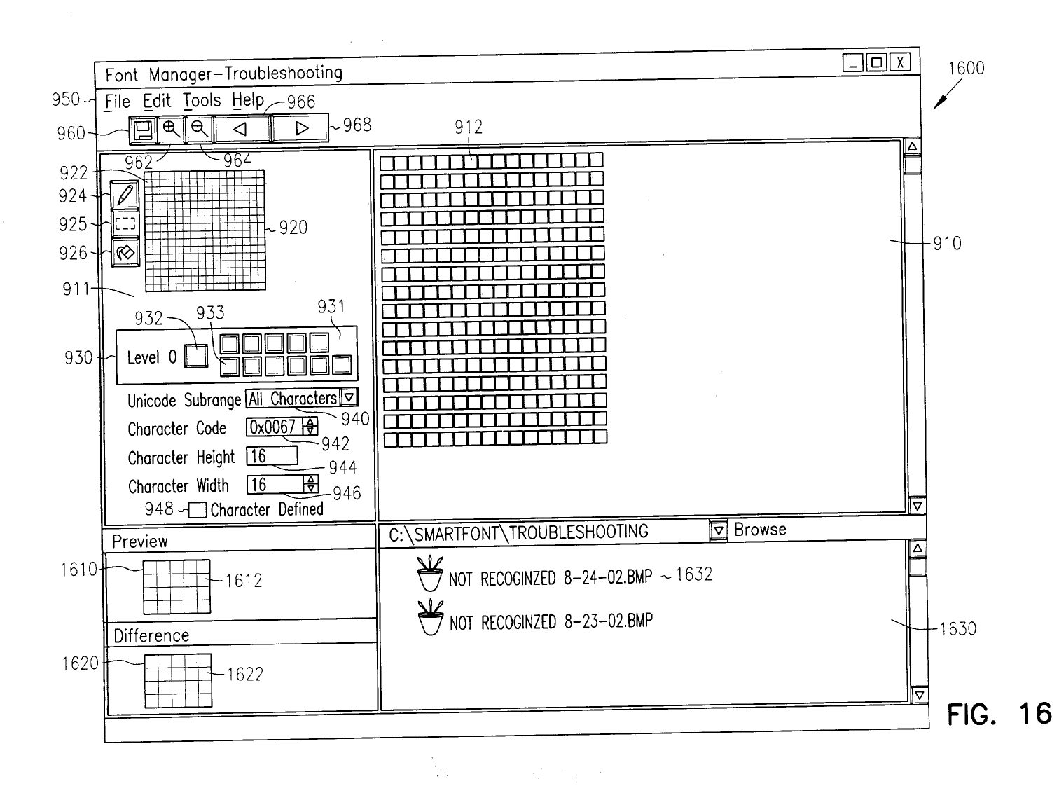

In some embodiments, as shown in FIG. 10, the graphical object defining, editing, and troubleshooting software 535 has several purposes. First, in some embodiments, the defining of graphical objects is performed manually using the interface 900 shown in FIG. 9. In one such embodiment, a testing system 505 user simply selects a menu 950 item for creating new graphical object definitions. The user interface 900 provides the user with a blank editing field 920 and the user fills in the appropriate pixels 922. In further embodiments, the user has the Font Learning Wizard, as described above, available for automating the learning of fonts. In some other embodiments, the graphical object defining, editing, and troubleshooting software 535 provides the user with the ability to troubleshoot system 505 recognition errors. Occasionally an embodiment of the system 505 might fail to recognize a graphical object properly. To allow a testing system user to determine and correct the reason for recognition failure, a troubleshooting graphical user interface 1600, as shown in FIG. 16, is provided. The testing system 505 stores copies of unrecognized graphical objects 1632 in storage 570. The troubleshooting graphical user interface 1600 is used to open stored unrecognized graphical objects 1632 for analysis. The stored unrecognized graphical objects 1632 are shown in sub-window 1630 of the graphical user interface. A testing system 505 user selects an unrecognized graphical object 1632 and it is displayed in the preview sub-window 1610. A testing system 505 user then selects the graphical object definition 522 in the sub-window 910. The graphical object definition 522 is then displayed in the pixel editing view 920 and the differences between the graphical object definition 522 and unrecognized graphical object 1632 are shown in the difference sub-window 1620. The testing system 505 user is able to edit the graphical object definition 522 as deemed necessary to allow for the testing system 505 to recognize the unrecognized graphical object 1632 in the future.

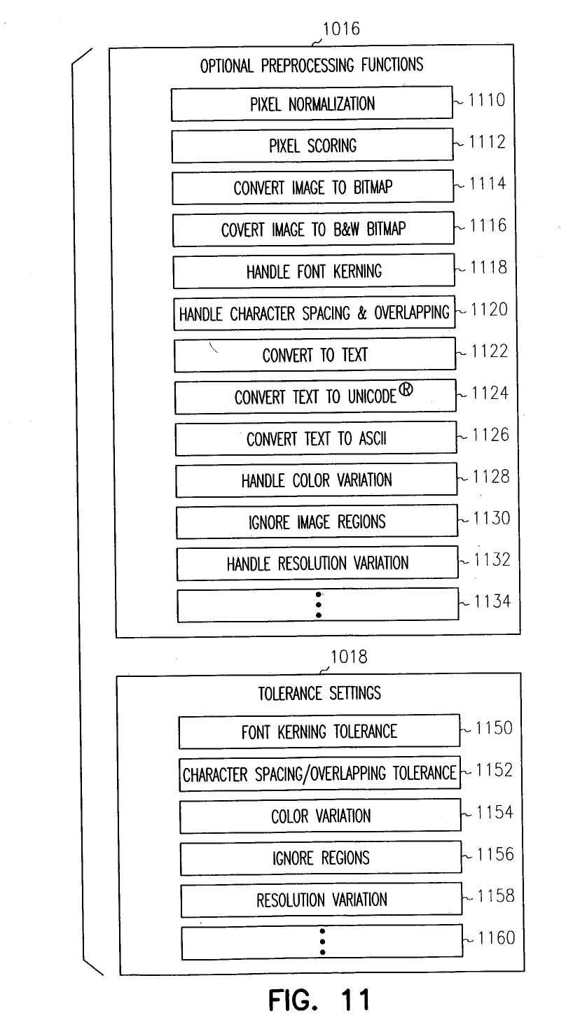

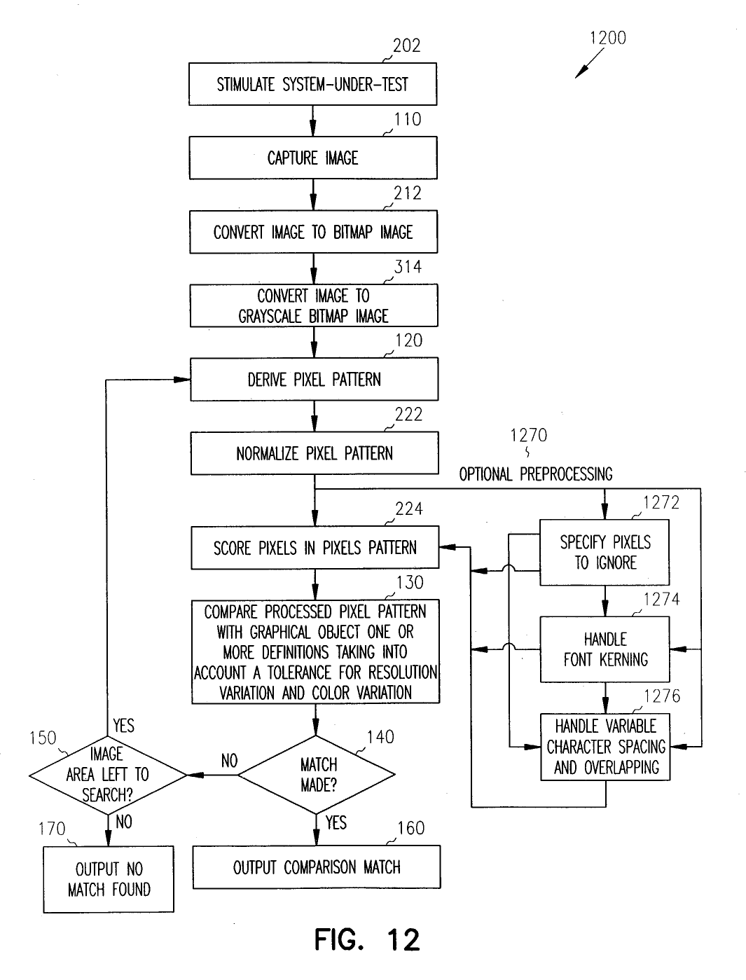

The optional processing functions 1016 of some embodiments of the system 505 are further detailed in FIG. 11. In some embodiments, the optional preprocessing functions 1016 take into account tolerance settings 1018, which are also detailed in FIG. 11. The optional preprocessing functions 1016 include, but are not limited to, functions for the following: normalizing 1110 pixels, pixel scoring 1112, converting 1114 an identified subregion 1014 of a captured image 1012 to a bitmap, converting 1116 an identified subregion 1014 of a captured image 1012 to a grey-scale bitmap, handling 1118 font kerning, handling 1120 variations in character spacing and overlapping, converting 1122 pixel patterns in an identified subregion 1014 to text, converting recognized text to Unicode®, converting 1126 recognized text to ASCII, handling 1128 color variations in an identified subregion 1014 of a captured image 1012, ignoring 1130 specified image regions, and handling 1132 resolution variation in an identified subregion 1014 of a captured image 1012. In various embodiments, these optional preprocessing functions 1016 take into account tolerance settings 1018 for font kerning 1150, variable character spacing and overlapping 1152, color variation 1154, ignore regions 1156, and resolution variation 1158.

### Conclusion

As shown in FIG. 1, one aspect of the present invention provides a computerized method 100 for testing an information-processing system-under-test 98. The method 100 includes capturing 110 an image 1012 (see FIG. 10) that represents a visual output 666 (see FIG. 6) of the system-under-test 98 (see FIG. 6), wherein the image 1012 (see FIG. 10) includes a plurality of pixels, and deriving 120 at least a first pixel pattern representing a first sub-portion 1014 (see FIG. 10) of the image 1012 (see FIG. 10). Further, the method 100 includes comparing 130 the first derived pixel pattern 120 with a prespecified graphical object definition 522 (see FIG. 5) and outputting 160 data representing results of the comparison 130.

In some embodiments, for example as shown in FIG. 2, a method 200 (for example, combined with method 100 of FIG. 1) includes normalizing 222 at least some of the pixels in the derived 120 pixel pattern.

In some embodiments, the deriving 120 of a pixel pattern of method 200 further includes extracting 211 a rectangular sub-portion 1014 (see FIG. 10) of the captured image 1012 (see FIG. 10) and the comparison 130 of the derived pixel pattern 120 with graphical object information includes performing text recognition on the extracted sub-portion.

In some embodiments, for example as shown in FIG. 2, method 200 includes stimulating 202 the information-processing system-under-test 98, wherein the capturing 110 of the image 1012 and comparing 130 are performed to test for an expected result of the stimulation 202.

In some embodiments of method 200, the captured 110 image is converted 212 to a bitmap image. In other embodiments, as shown in FIG. 3, the converted 212 bitmap image is further converted 314 to a grey-scale bitmap image.

In some embodiments of method 200, after deriving 120 and normalizing 222 a pixel pattern, the pixels are scored 224 according to color intensity. The scoring 224 allows for comparing 130 based on pixel pattern and color intensity.

In some embodiments, as shown in FIG. 3, the prespecified graphical object definition 522 for the comparing 130 includes a character glyph 333 used in a written language. In one such embodiment, the written language is English. In another such embodiment, the language is Hebrew. In yet another embodiment, there are three written languages: Hebrew, English, and Chinese. In some embodiments, the prespecified graphical object definition 522 is of a character glyph 333 that is a member of the Unicode® set of characters. In some embodiments, the character glyph 333 is in a Roman font.

In some embodiments, the output 160 of method 100 includes a text string 722 corresponding to text recognized 420 in the derived 120 pixel pattern. In another embodiment of method 100, the output 160 includes a set of coordinates 732 representing a location within the captured image 110 where the compared 130 graphical object is located.

In some embodiments of method 100, the prespecified graphical object definition 522 used in comparing 130 includes an icon definition 624. In another embodiment, the prespecified graphical object definition 522 used in comparing 130 includes a picture definition 628.

In some embodiments of computerized method 100, the computer 505 implementing the method 100 is connected to a database that stores a plurality of graphical object definitions 522 used in the comparing 130.

In some embodiments, as shown in FIG. 12, the computerized method 1200 includes optional pre-processing 1270. In these embodiments, the optional pre-processing 1270 includes any combination of ignoring 1272 specific pixels in a captured image 1012, handling 1274 font kerning, and handling 1276 variable graphical object spacing and overlapping.

In some embodiments, also shown in FIG. 12, the comparing 130 of pixel patterns with graphical object definitions 522 includes taking into account tolerances 1018 for variation between the captured image 110 and a graphical object definition 522. In several embodiments, these tolerances 1018 include font kerning 1150, variable character spacing and overlapping 1152, color variation 1154, and resolution variation 1158.

In some embodiments, as shown in FIG. 4, the computerized method 400 includes executing 202 a stimulation command 635 on a system-under-test 98, capturing 110 a video-output from a visual display driver 99 of the system-under-test 98, performing 420 text recognition on the captured video-output 110, and outputting 430 a result based on the text recognition 420. In some embodiments, output 430 includes a text string 722 of recognized text 420. In other embodiments, output 430 also includes an R,G,B code 742 representing the color of the text 722 in the captured 110 video-output and a set of coordinates 732 representing a location within the captured 110 video-output.

Another aspect of the present invention, as shown in FIG. 13, provides a computer-readable media 652 that includes instructions 1320 coded thereon that when executed on a suitably programmed computer 505, executes one or more of the above methods.

Yet another aspect of the present invention, again shown in FIG. 6, provides a computerized system 505 for testing an information-processing system-under-test 98, wherein the information-processing system-under-test 98 has a visual display driver 99. In some embodiments, the computerized system 505 includes a memory 510, one or more graphical object definitions 522 stored in the memory 510, an image-capture device 530 coupled to the memory 510 that captures an image 1012 having a plurality of pixels from the visual display driver 99 of the information processing system-under-test 98. Additionally in these embodiments, the computerized system 505 includes commands 532 stored in the memory 510 to derive at least a first pixel pattern representing at least a portion of the image 1014 from the image-capture device 530, a comparator 540 coupled to the memory 510 that generates a result 160 based on a comparison 130 of the first derived pixel pattern with a graphical object definition 522, and an output device 560 coupled to the memory 510 that outputs data 160 representing a result from the comparator 540.

In another embodiment of the present invention, as shown in FIG. 6, the commands 631 stored in memory 510 further include commands 633 to normalize at least some of the pixels in at least a first derived 530 pixel pattern.

In some embodiments, again shown in FIG. 6, computerized system 505 includes a stimulation output port 660 that connects to inputs 97 of the information-processing system-under-test 98 and a plurality of stimulation commands 633 stored in the memory 510 that drive the output port 660 to stimulate the information processing system-under-test 98, wherein the image-capture device 530 and comparator 540 are used to test for an expected result of at least one of the stimulation commands 633.

In yet another embodiment, computerized system 505 includes an input port 664 coupled to the image-capture device 530 that receives video-output signals from the visual display driver 99 of the system-under-test 98.

In some embodiments, as shown in FIG. 6, computerized system 505 includes commands 631 stored in the memory 520 to cause the captured image 1012 to be stored in the memory 510 as a bitmap image 642. In some embodiments, computerized system 505 also includes commands 631 stored in memory 510 to cause the captured image 1012 to be stored in memory 510 as a grey-scale bitmap image 644. In other embodiments, computerized system 505 includes commands 631 stored in the memory 510 to normalize 632 at least a first pixel pattern of a captured image 1012. In one such embodiment, the commands 632 further include commands 631 stored in the memory 5 10 to derive 636 a score for each pixel corresponding to color intensity.

In some embodiments, the output 160 of the computerized system 505 from the output device 560 includes a text string 722 as shown in FIG. 7A. In other embodiments, the output 160 from the output device 560 includes data 732 specifying a set of coordinates representing a location within a captured image 1012 where a prespecified graphical object 522 is located.

In other embodiments, as shown in FIG. 6, the computerized system 505 is connected to a database 672. In one such embodiment, a plurality of graphical object definitions 522 are stored in the database 672.

In some embodiments, as shown in FIGS. 10 and 11, the computerized system 505 includes optional preprocessing 1020 of an identified subregion 1014 of a captured image 1012 in memory 510. The optional preprocessing 1020 includes functions 1016 located in memory 510 that have tolerance setting 1018 inputs stored in the memory 510. In some embodiments, the preprocessing functions 1016 include functions for normalizing 1110 pixels, pixel scoring 1112, converting 1114 an identified subregion 1014 of a captured image 1012 to a bitmap, converting 1116 an identified subregion 1014 of a captured image 1012 to a grey-scale bitmap, handling 1118 font kerning, handling 1120 variations in character spacing and overlapping, converting 1122 pixel patterns in an identified subregion 1014 to text, converting recognized text to Unicode®, converting 1126 recognized text to ASCII, handling 1128 color variations in an identified subregion 1014 of a captured image 1012, ignoring 1130 specified image regions, and handling 1132 resolution variation in an identified subregion 1014 of a captured image 1012. In some embodiments, the tolerance setting 1018 inputs include a font kerning tolerance setting 1150, a character spacing and overlapping tolerance setting 1152, a color variation tolerance setting 1154, an ignore region setting, and a resolution variation tolerance setting 1158.

In some embodiments, computerized system 505 includes software 535 that allows for defining, editing, and troubleshooting graphical object definitions, including character glyphs. In some of these embodiments, the software 535 also provides the ability to create and modify a non-zero tolerance of color variation used in the comparison 130 of pixels. In some further embodiments, the software 535 allows for specifying interior regions of graphical objects to ignored and handles resolution variations during pixel comparing 130.

It is understood that the above description is intended to be illustrative, and not restrictive. Many other embodiments will be apparent to those of skill in the art upon reviewing the above description. The scope of the invention should therefore, be determined with reference to the appended claims, along with the full scope of equivalents to which such claims are entitled.

What is claimed is:

1. A computerized method for testing an information-processing system-under-test, the method comprising:
capturing an image that represents a visual output of the system-under-test, wherein the image includes a plurality of pixels;
deriving at least a first pixel pattern representing a first sub-portion of the image;
comparing the first derived pixel pattern with a prespecified graphical object; and
outputting data representing results of the comparison.

2. The method of claim 1, wherein the deriving further includes normalizing at least some of the pixels in the derived pattern.

3. The method of claim 1, wherein the deriving includes:
extracting a rectangular sub-portion of the image; and
performing text recognition on the extracted sub-portion.

4. The method of claim 1, further comprising:
stimulating the information-processing system, wherein the capturing of the image and comparing are performed to test for an expected result of the stimulation.

5. The method of claim 2, wherein normalizing each image pixel includes deriving a score corresponding to color intensity.

6. The method of claim 1, wherein the prespecified graphical object includes a character glyph used in a written language.

7. The method of claim 1, wherein the output data includes a text string corresponding to text detected in the derived pixel pattern.

8. The method of claim 1, wherein the output data includes a set of coordinates representing a location within the captured image where the compared graphical object is located.

9. The method of claim 1, further comprising:
connecting the computerized system to a database; and
storing a plurality of graphical object definitions in the database.

10. The method of claim 1, wherein:
the pixel comparing includes a non-zero tolerance of color variation;
the pixel comparing includes ignoring specified interior regions of graphical objects;
the pixel comparing includes tolerating font kerning variation;
the pixel comparing includes handling variable spacing and overlapping between graphical objects; and
the pixel comparing includes handling resolution variations in the visual output of the system.

11. A computer-readable media comprising instructions coded thereon that, when executed on a suitably programmed computer, executes the method of claim 1.

12. A computerized system for testing an information-processing system-under-test, the information-processing system-under-test having a visual display driver, the computerized system comprising:
a memory;
one or more graphical object definitions including a first graphical object definition stored in the memory;
an image-capture device coupled to the memory that captures an image of the visual display driver of the information processing system-under-test, wherein the captured image includes a plurality of pixels;
commands stored in the memory to derive at least a first pixel pattern representing at least a portion of the image from the image-capture device;
a comparator coupled to the memory that generates a result based on a comparison of the first derived pixel pattern with the first graphical object definition; and
an output device coupled to the memory that outputs data representing a result from the comparator.

13. The commands stored in memory to derive at least a first pixel pattern of claim 12, wherein the commands further comprise:
commands that normalize at least some of the pixels in the derived pattern.

14. The computerized system of claim 12, further comprising:
a stimulation output port that connects to inputs of the information-processing system-under-test; and
a plurality of stimulation commands stored in the memory that drive the output port to stimulate the information processing system-under-test, wherein the image-capture device and comparator are used to test for an expected result of at least one of the stimulation commands.

15. The computerized system of claim 14, further comprising:
an input port coupled to the image-capture device that receives video-output signals of the system-under-test.

16. The commands stored in the memory to normalize at least a first pixel pattern of a captured image of claim 13, wherein the commands further comprise:
commands stored in the memory to derive a score for each pixel corresponding to color intensity.

17. The output device of claim 12, wherein the device output includes a text string.

18. The output device of claim 12, wherein the device output includes data specifying a set of coordinates representing a location within a captured image where a prespecified graphical object is located.

19. The computerized system of claim 12, further comprising:
a database; and
a plurality of graphical object definitions stored in the database.

20. The computerized system of claim 12, further comprising:
software specifying pixel comparison including a non-zero tolerance of color variation, ignoring specified interior regions of graphical objects, tolerating font kerning variation variable spacing, and overlapping between graphical objects; and
software specifying handling resolution variations in the visual output of the system-under-test.

21. A computerized system of claim 12, further comprising:
software specifying defining, editing, and troubleshooting one or more character sets of a written language, the one or more character sets including fonts with and without kerning;
software specifying creating and modifying a non-zero tolerance of color variation used in the pixel comparing;
software specifying interior regions of graphical objects to ignored during the pixel comparison; and
software specifying how to handle resolution variations during the pixel comparison.

22. A computerized method for testing a function of an information-processing system-under-test, the method comprising:
executing a stimulation command;
capturing a video-output of the system-under-test;
performing text recognition on the captured video-output; and
outputting a result based on the text recognition.

23. The method of claim 22, further comprising:
storing the captured video-output as a bitmap image, the bitmap image including a plurality of pixels; and
deriving at least a first pixel pattern representing at least a portion of the bitmap image.

24. The method of claim 23, further comprising:
normalizing at least some of the pixels in the derived pattern.

25. The method of claim 24, further comprising:
deriving a score for at least some of the normalized pixels in the derived pattern, the score corresponding to color intensity.

26. The method of claim 22, further comprising:
storing a plurality of text definitions on a database coupled to a computerized system suitably configured to perform the method.

27. The method of claim 22, wherein the performance of text recognition includes comparing at least a region of the captured video-output with a prespecified text definition.

28. The method of claim 27, wherein the prespecified text definition includes a definition of a character glyph used in a written language.

29. The method of claim 22, wherein the output result includes a text string corresponding to text extracted from the captured video-output and a set of coordinates representing a location within the captured video-output.

30. A computerized system comprising:
a memory;
a plurality of graphical object definitions stored in the memory;
an image capture device coupled to the memory;
means for extracting graphical object information from the captured image and for comparing the graphical object information to at least one of the prespecified graphical object definitions;
an output device coupled to the means for extracting and comparing that outputs data representing a result of the comparison.
